(19) United States
(12) Patent Application Publication
(10) Pub. No.: US 2007/0195673 A1
(43) Pub. Date: Aug. 23, 2007

(54) Method and apparatus for recording information on super-resolution optical recording medium

(75) Inventors: Tatsuhiro Kobayashi, Tokyo (JP); Takashi Kikukawa, Tokyo (JP); Narutoshi Fukuzawa, Tokyo (JP)

Correspondence Address: OLIFF & BERRIDGE, PLC, P.O. BOX 19928, ALEXANDRIA, VA, 22320, US

(73) Assignee: TDK CORPORATION, TOKYO (JP)

(21) Appl. No.: 11/705,462

(22) Filed: Feb. 13, 2007

(30) Foreign Application Priority Data
Feb. 20, 2006 (JP) 2006-043070

(51) Int. Cl. G11B 7/0045

(52) U.S. Cl. 369/59.11; 369/59.12

(57) ABSTRACT

A method for recording information on a super-resolution optical recording medium is directed to a reproducing laser beam which moves during the reproduction of the super-resolution optical recording medium from a recording mark/space train smaller than the resolution limit to a recording mark, or mark/space train larger than or equal to the resolution limit. A pulse train employed by the method for forming a recording mark larger than or equal to the resolution limit immediately after a smaller space than the resolution limit of a reproduction optical system includes at least a first ON pulse T₁ of recording power followed by a first OFF pulse and second ON pulses T₂₁ and T₂₂ in that order. The first OFF pulse includes an OFF pulse Pc of cooling power and an OFF pulse Pm of middle power in that order.

### BACKGROUND OF THE INVENTION

1. Field of the Invention

The present invention relates to a method and apparatus for recording information on an optical recording medium which enables the reproduction of information thereon by illuminating the recording marks formed on a recording layer with a reproducing beam. In particular, the invention relates to a method and apparatus for recording information on an optical recording medium which enables reproducing of recording marks that are smaller than the resolution limit of a reproduction optical system.

2. Description of the Related Art

Recently, as described in, for example, Japanese Patent Laid-Open Publication No. 2003-6872, a super-resolution optical recording medium has been suggested which enables the reproduction of a recording mark/space train that is smaller than the diffraction limit of a reproduction optical system.

This super-resolution optical recording medium enables the reproduction of a minute recording mark (also known as a super-resolution recording mark) that is smaller than the resolution limit of a reproduction optical system, however, the principle of how this is enabled has not yet been made known.

In general, a recording mark/space train consists of two parts on a recording layer that have different reflectivities with one section referred to as a recording mark and the other section referred to as a space. The recording mark can be reproduced when it is larger than λ/4NA which is the resolution limit in the scanning direction of a laser beam, where λ is the wavelength of the reproducing laser beam and NA is the numerical aperture of the objective lens.

Additionally, a reproduction method which uses a light beam cannot read a recording mark/space train which has a period that is less than or equal to a certain recording mark/space train period length. The length of this recording mark/space train period is referred to as the diffraction limit. A reproduction optical system with a wavelength λ and a numerical aperture NA gives a diffraction limit of λ/NA/2. If the recording mark section and the space section have the same length in one period, the recording mark length is given by λ/NA/4. This recording mark length is referred to as the resolution limit.

To obtain a higher recording density for an optical recording medium such as that mentioned above, the wavelength λ has to be reduced or the NA needs to be increased, however both of these variables have limitations.

In contrast to this, the super-resolution optical recording medium mentioned above has been suggested in the case where there occurs a recording pattern which contains a mixture of a recording mark/space train which is smaller than the resolution limit, and a recording mark/space train which is larger than or equal to the resolution limit, as described in Japanese Patent Laid-Open Publication No. 2004-134052.

However, in such a case, there has been a problem in that during the reproduction of the super-resolution optical recording medium, degradation in signal quality has occurred as a result of the reproducing laser beam being moved from a space smaller than the resolution limit to a recording mark larger than or equal to the resolution limit.

### SUMMARY OF THE INVENTION

In view of the foregoing problems, various exemplary embodiments of this invention provide a method and apparatus for recording information on a super-resolution optical recording medium which is capable of preventing degradation of signal quality and improving the signal quality when a reproducing laser beam moves from a space smaller than the limit resolution to a recording mark larger than or equal to the resolution limit during the reproduction of the super-resolution optical recording medium.

As a result of intensive studies, the inventor of the present invention has found that one cause of the degradation in signal quality, which occurs when a reproducing laser beam moves from a space smaller than the resolution limit to a recording mark larger than or equal to the resolution limit during the reproduction of the super-resolution optical recording medium, is degradation in recording status of the smaller space and the larger recording mark. That is, it was found that when a larger recording mark was formed, the smaller preceding space was significantly distorted leading to this degradation. It was thus found that by preventing this distortion during recording, the recording status is improved, and the signal quality is increased during reproduction.

In summary, the above-described objectives are achieved by the following embodiments of the present invention.

(1) A method for recording information on a super-resolution optical recording medium by irradiating the medium with a laser beam in accordance with a pulse train, which is defined according to data to be recorded, in order to record information by forming a recording mark/space train that includes a recording mark/space which are smaller than a resolution limit of a reproduction optical system, and a recording mark/space which are larger than or equal to the resolution limit, wherein the pulse train for forming the larger recording mark immediately after the smaller space includes a first ON pulse of recording power followed by a first OFF pulse and a second ON pulse in that order, and the first OFF pulse includes an OFF pulse of cooling power and an OFF pulse of middle power in that order.

(2) The method for recording information on a super-resolution optical recording medium according to (1), wherein the first ON pulse has a length which is made equal to a length of a recording pulse for forming the small recording mark.

(3) The method for recording information on a super-resolution optical recording medium according to (1) or (2), wherein the length of the first OFF pulse is greater than or equal to 1T and less than or equal to 3T, where T is one clock cycle, and the larger recording mark has a length which is an integral multiple of T.

(4) An apparatus for recording information on a super-resolution optical recording medium by irradiating the medium with a laser beam in accordance with a pulse train, which is defined according to data to be recorded, in order to record information by forming a recording mark/space train that includes a recording mark/space which are smaller than a resolution limit of a reproduction optical system and a recording mark/space which are larger than or equal to the resolution limit, the apparatus comprising: a head for irradiating the super-resolution optical recording medium with the laser beam; a laser drive circuit for supplying to the head a laser drive signal for controllably modulating the laser beam into a recording pulse train; and a laser control circuit for generating the laser drive signal such that a pulse train for forming the larger recording mark immediately after the smaller space includes at least a first ON pulse of recording power followed by a first OFF pulse and a second ON pulse in that order, and the first OFF pulse includes an OFF pulse of cooling power and an OFF pulse of middle power in that order.

(5) The apparatus for recording information on a super-resolution optical recording medium according to (4), wherein the laser control circuit generates the laser drive signal so that the first OFF pulse has a length which is made equal to a length of a recording pulse for forming the smaller recording mark.

(6) The apparatus for recording information on a super-resolution optical recording medium according to (4) or (5), wherein the laser control circuit generates the laser drive signal such that the length of the first OFF pulse is greater than or equal to 1T and less than or equal to 3T, where T is one clock cycle, and the larger recording mark has a length which is an integral multiple of T.

According to the present invention, when recording marks are formed on a super-resolution optical recording medium, the distortion of a space smaller than the resolution limit preceding a recording mark larger than or equal to the resolution limit can be prevented, thereby realizing improved signal quality during the reproduction of the super-resolution optical recording medium.

### BRIEF DESCRIPTION OF THE DRAWINGS

FIG. 1 is an enlarged schematic cross-sectional view illustrating the main portion of a super-resolution optical recording medium according to an exemplary embodiment of the present invention;

FIG. 2 is a block diagram schematically illustrating an information recording and reproducing apparatus according to an exemplary embodiment of the present invention;

FIG. 3 is a diagram illustrating the recording strategy for recording a 2T mark/space train and a 7T mark/space train in accordance with an exemplary embodiment of the present invention;

FIG. 4 is a diagram illustrating the recording strategy for recording a 2T mark/space train and a 7T mark/space train, employed when a second ON pulse has a length of 1.6T, in accordance with an exemplary embodiment of the present invention;

FIG. 5 is a diagram illustrating the waveform of a reproduction signal from a 2T mark/space train and a 7T mark/space train that have been recorded in accordance with an exemplary embodiment of the present invention;

FIG. 6 is a diagram illustrating the waveform of a reproduction signal from a 2T mark/space train and a 7T mark/space train when the 2T mark/space train and the 7T mark/space train have been recorded on a BD (Blu-ray Disc™);

FIG. 7 is a diagram illustrating the waveform of a reproduction signal from a 2T mark/space train and a 7T mark/space train when the 2T mark/space train and the 7T mark/space train have been recorded on a BD;

FIG. 8 is a diagram illustrating a 7T mark/space train recording strategy employed when a 2T mark/space train and a 7T mark/space train are recorded without consideration of the distortion of the 2T space; and

FIG. 9 is a diagram illustrating the waveform of a reproduction signal from a 2T mark/space train and a 7T mark/space train that have been recorded without consideration of the distortion of the 2T space.

### DETAILED DESCRIPTION OF THE PREFERRED EMBODIMENTS

According to the best mode of the present invention, there is provided a method for recording information on a super-resolution optical recording medium. The medium is irradiated with a laser beam in accordance with a pulse train, which is defined according to data to be recorded, in order to record information by forming a recording mark/space train. The recording mark/space train includes a recording mark/space which are smaller than the resolution limit of a reproduction optical system, and a recording mark/space which are larger than or equal to the resolution limit. The pulse train for forming the larger recording mark immediately after the smaller space includes a first ON pulse of recording power followed by a first OFF pulse and a second ON pulse in that order. The first OFF pulse includes an OFF pulse of cooling power and an OFF pulse of middle power in that order. The length of the first ON pulse is made equal to the length of a recording pulse for forming the small recording mark, thereby preventing distortion of the smaller space, providing an improved recording status, and realizing improved signal quality during reproduction. The second ON pulse may also be divided into two or more pulses.

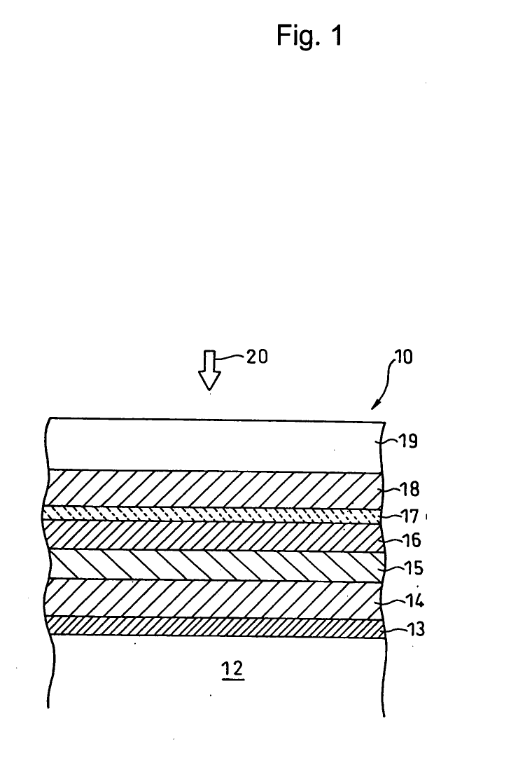

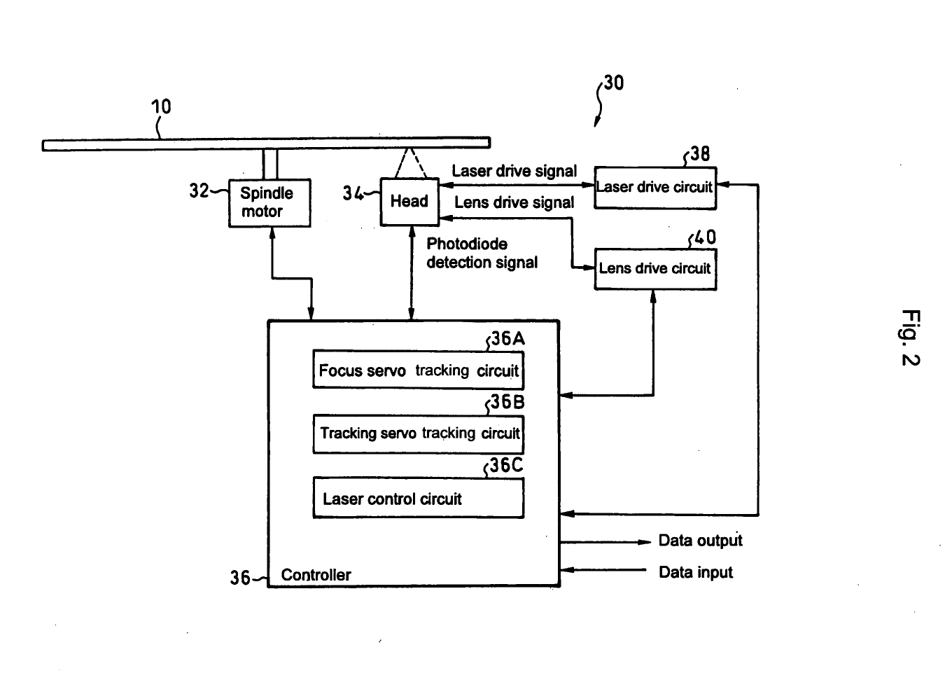

The present invention will now be described in more detail in accordance with the exemplary embodiment and with reference to FIGS. 1 and 2.

In the present exemplary embodiment, an information recording and reproducing apparatus 30 shown in FIG. 2 is used to record and reproduce information on a super-resolution optical recording medium 10.

As shown in FIG. 1, the super-resolution optical recording medium 10 includes a reflective layer 13, a third dielectric layer 14, a light-absorbing layer 15, a second dielectric layer 16, a decomposition layer 17 which is predominantly composed of platinum oxide, a first dielectric layer 18, and a light-transmitting layer 19, all of which are formed on a substrate 12 in that order. When irradiated with a laser beam 20 via the light-transmitting layer 19, the decomposition layer 17 which is predominantly composed of platinum metal oxide is decomposed into platinum and oxygen, so that the resulting oxygen gas forms a void, in which fine particles of platinum are precipitated to form a recording mark in the decomposition layer 17.

The information recording and reproducing apparatus 30 includes a spindle motor 32 for rotating the super-resolution optical recording medium 10, a head 34 for irradiating the super-resolution optical recording medium 10 with a laser beam, a controller 36 for controlling the head 34 and the spindle motor 32, a laser drive circuit 38 for supplying a laser drive signal to controllably modulate the laser beam from the head 34 into a pulse train, and a lens drive circuit 40 for supplying a lens drive signal to the head 34.

The controller 36 includes a focus servo tracking circuit 36A, a tracking servo tracking circuit 36B, and a laser control circuit 36C.

The laser control circuit 36C generates the laser drive signal, which is in turn delivered by the laser drive circuit 38, and is configured to generate an appropriate laser drive signal during recording of data in accordance with recording condition setting information stored on the super-resolution optical recording medium of interest.

The “recording condition setting information” refers to such information that is used to identify various types of conditions required for recording data on the super-resolution optical recording medium. In this exemplary embodiment, the recording condition setting information contains at least such information that is necessary to determine the recording strategy. The recording strategy will be discussed in detail below.

The recording condition setting information includes not only such information as that which specifically represents each condition required for recording data but also such information that identifies the recording condition by specifying any of each type of condition that is pre-stored in the information recording and reproducing apparatus.

During recording, a laser beam is pulse modulated to irradiate the recording layer, and the settings such as a pulse number, pulse width, pulse interval, and power used for modulation are referred to as the “recording strategy.”

Data to be recorded is modulated into the length of a recording mark along a track of the recording layer, and is recorded with the length of the recording mark/space associated with nT or an integral multiple of T, where T is one clock cycle.

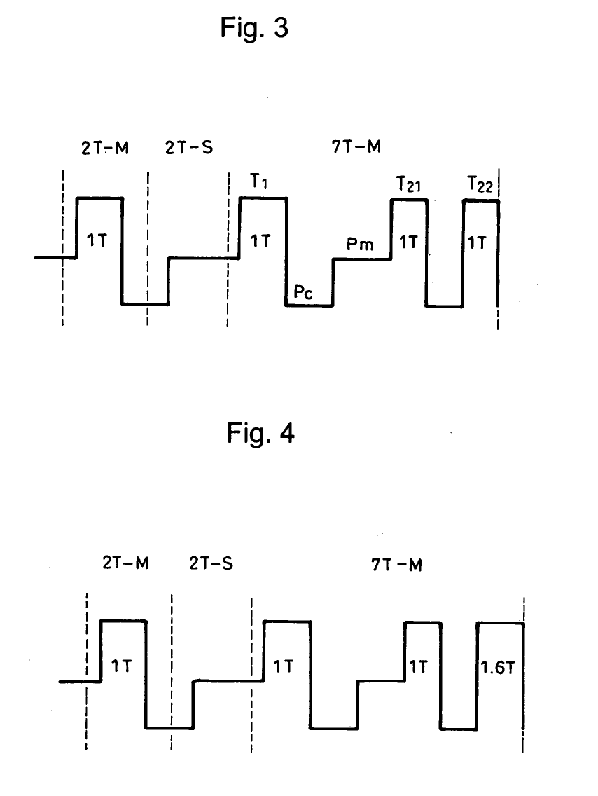

More specifically, the laser control circuit 36C is configured to supply to the laser drive circuit 38 a laser drive signal to create a pulse train for forming a smaller space than the resolution limit of the reproduction optical system (e.g., 2T space) immediately followed by a recording mark larger than the resolution limit of the reproduction optical system (e.g., 7T mark). For example, as shown in FIG. 3, the pulse train includes a first ON pulse T₁ of recording power followed by a first OFF pulse and then a second ON pulse T₂ to be formed in that order, in which the first OFF pulse includes an OFF pulse Pc of cooling power and an OFF pulse Pm of middle power in that order.

FIG. 3 is a diagram illustrating the recording strategy for recording a 2T mark/space train and a 7T mark/space train in accordance with this exemplary embodiment. In FIG. 3, the recording strategy for recording a 2T mark is indicated by 2T-M, the recording strategy for recording the subsequent space is indicated by 2T-S, and the recording strategy for recording a 7T mark is indicated by 7T-M.

According to this recording strategy, the second ON pulse is divided into two pulses, which are indicated by T₂₁ and T₂₂, respectively. The laser control circuit 36C is provided with such settings that each of T₁, T₂₁, and T₂₂ is equal to 1T, and the length of the first ON pulse T₁ is equal to the length of the ON pulse contained in 2T-M.

The laser control circuit 36C is also provided with such a setting that the sum of the length of the OFF pulse Pc of cooling power and the length of the OFF pulse Pm of middle power is greater than or equal to 1T and less than or equal to 3T.

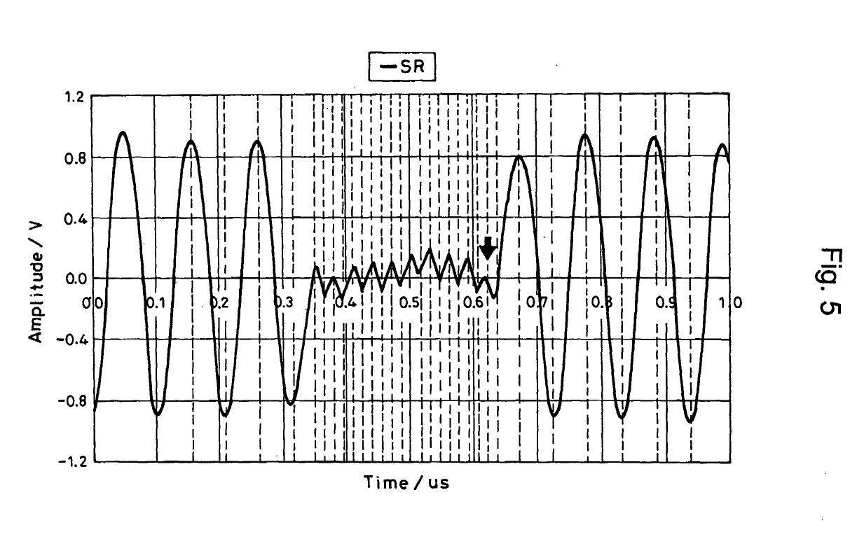

This makes it possible to reduce the distortion of the 2T space, which is immediately preceding to the 7T space, to the same extent as that of the preceding space which occurs when the 2T mark is formed. In this instance, since sufficient cooling is provided by a cooling power during 1T or more, the second ON pulse T₂₂ can be made longer, up to 1.6T without having an effect on the preceding space. The recording strategy employed in this case is shown in FIG. 4.

FIG. 5 shows the waveform of a reproduction signal from the 2T mark/space train and the 7T mark/space train that have been recorded using the recording strategy shown in FIG. 4. As illustrated by the arrow in the figure, the tenth crest of the 2T mark/space train can be clearly seen. This figure shows that the reproduction signal has not been degraded even when the reproducing laser beam moves from the 2T space to the 7T mark.

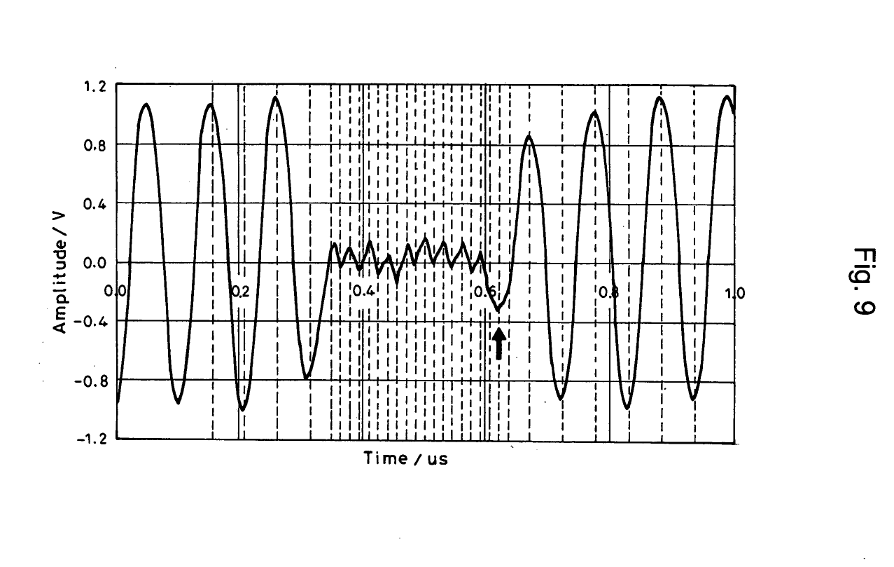

As a comparative example, FIG. 9 shows the waveform of a reproduction signal from the 2T mark/space train and the 7T mark/space train which have been recorded without consideration of the distortion of the 2T space. In FIG. 9, a solid line is used to express the reproduction signal which has been employed for recording the 7T mark with the pulse train shown in FIG. 8. As illustrated by the arrow in the figure, the tenth crest of the 2T mark/space train is not found. This figure shows that the reproduction signal has been degraded when the reproducing laser beam moves from the 2T space to the 7T mark.

FIGS. 5 and 9 show that the present exemplary embodiment has improved the quality of the reproduction signal.

That is, when recorded without consideration of the distortion of a preceding space, a larger recording mark has an effect on the preceding space, thereby causing a signal from the smaller space to not appear on the waveform.

Measurements made on the reproduction signal from the super-resolution optical recording medium according to the present exemplary embodiment show that the smaller space was distorted when the larger recording mark was recorded and thus, according the present exemplary embodiment, a compensation was required. This happened when the length of the smaller space was either 2T (75 nm) or 3T (112.5 nm), and the length of the larger recording mark was any one of 4T (150 nm), 5T (187.5 nm), 6T, (225 nm), 7T (262.5 nm), and 8T (300 nm).

When the smaller space had a length in the range of 4T to 8T, the smaller space was not distorted during recording of the larger recording mark, and thus, according the present exemplary embodiment, no compensation was required. That is, when the length of the smaller space is either 2T or 3T and the length of the larger recording mark is any one of 4T to 8T, according the present exemplary embodiment, a compensation is required.

These findings are indicated in Table 1 with a circle (∘) for the case where a compensation is required in accordance with the present exemplary embodiment and a cross (×) for the case where a compensation is not required.

TABLE 1

| | | Smaller space | | | | | | |
|---|---|---|---|---|---|---|---|---|
| | | 2T | 3T | 4T | 5T | 6T | 7T | 8T |
| Larger | 2T(75 nm) | x | | | | | | |
| recording | 3T(112.5 nm) | x | x | | | | | |
| mark | 4T(150 nm) | ∘ | ∘ | x | | | | |
| | 5T(187.5 nm) | ∘ | ∘ | x | x | | | |
| | 6T(225 nm) | ∘ | ∘ | x | x | x | | |
| | 7T(262.5 nm) | ∘ | ∘ | x | x | x | x | |
| | 8T(300 nm) | ∘ | ∘ | x | x | x | x | x |

∘: Correction required
x: Correction not required

The recording strategy before a compensation according to the present exemplary embodiment and the recording strategy after a compensation are shown in Table 2 for the cases with the circles indicated in Table 1.

TABLE 2

| | Before correction | After correction |
|---|---|---|
| 4T | 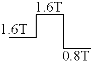 | 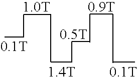 |
| 5T | 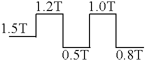 | 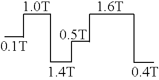 |
| 6T | 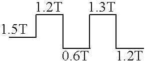 | 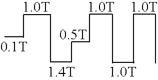 |
| 7T | 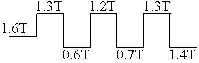 | 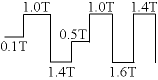 |
| 8T | 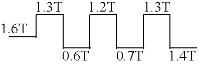 | 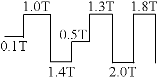 |

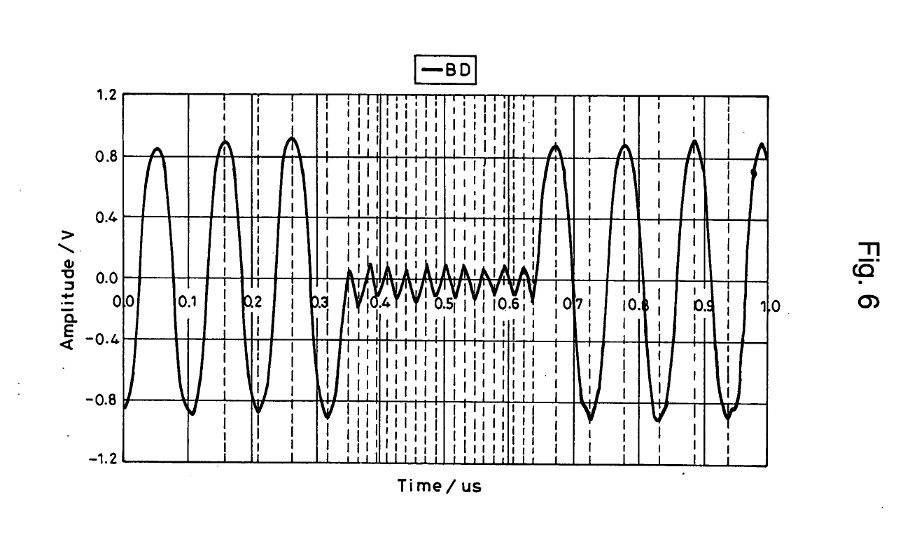

FIG. 6 shows the waveform of a reproduction signal from a 2T mark/space train and a 7T mark/space train that have been recorded on a BD 23 GB (BD with a recording capacity of 23 GB) using an information recording and reproducing apparatus, having an optical system with λ=405 nm and NA=0.85, for an optical recording medium referred to as a BD, which is adapted for a blue-violet laser under a condition of 2T=160 nm. FIGS. 5 and 6 show that in terms of a local pattern, the waveform of the reproduction signal from the recording mark recorded according to the present exemplary embodiment is generally equivalent to the waveform of the reproduction signal from the BD 23 GB on which recording was carried out as described above.

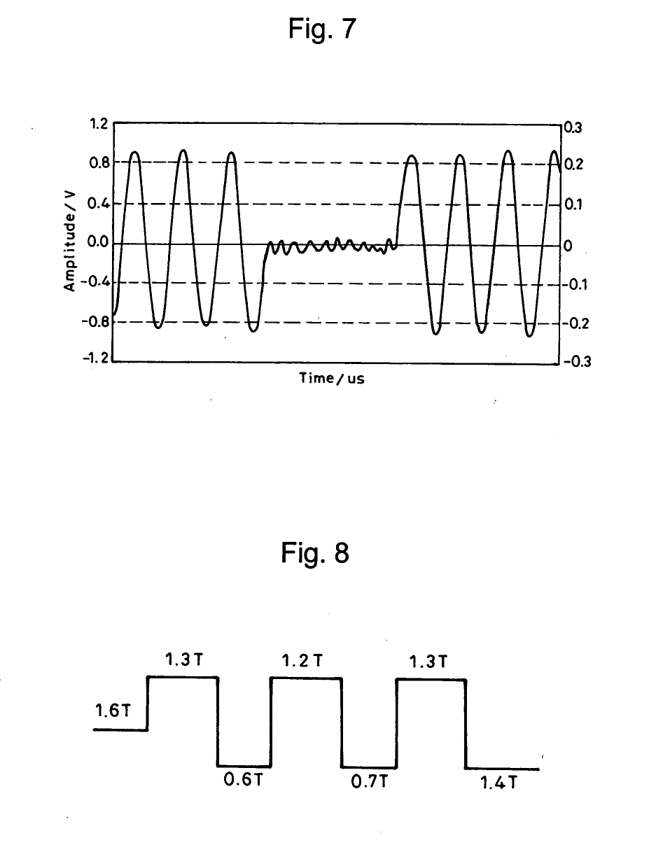

FIG. 7 shows the waveform of a reproduction signal from a 2T mark/space train and a 7T mark/space train which have been recorded on a BD25 GB using an information recording and reproducing apparatus for BD under a condition of 2T=150 nm. FIGS. 5 and 7 show that the 2T resolution of a recording mark which was recorded according to the present exemplary embodiment is equivalent to or better than the 2T resolution of a recording mark which was recorded on the BD25 GB as described above.

Note that the present exemplary embodiment is directed to a recording modulation code with (1,7) RLL, however, without being limited thereto, the present invention is also applicable to another recording modulation code.

Furthermore, the present exemplary embodiment is also directed to a 2T mark having a length of 75 nm, however, without being limited thereto, the present invention is also applicable to a 2T mark having different lengths.

What is claimed is:

1. A method for recording information on a super-resolution optical recording medium by irradiating the medium with a laser beam in accordance with a pulse train, which is defined according to data to be recorded, in order to record information by forming a recording mark/space train that includes a recording mark/space which are smaller than a resolution limit of a reproduction optical system, and a recording mark/space which are larger than or equal to the resolution limit, wherein
the pulse train for forming the larger recording mark immediately after the smaller space includes a first ON pulse of recording power followed by a first OFF pulse and a second ON pulse in that order, and the first OFF pulse includes an OFF pulse of cooling power and an OFF pulse of middle power in that order.

2. The method for recording information on a super-resolution optical recording medium according to claim 1, wherein the first ON pulse has a length which is made equal to a length of a recording pulse for forming the small recording mark.

3. The method for recording information on a super-resolution optical recording medium according to claim 1, wherein the length of the first OFF pulse is greater than or equal to 1T and less than or equal to 3T, where T is one clock cycle, and the larger recording mark has a length which is an integral multiple of T.

4. The method for recording information on a super-resolution optical recording medium according to claim 2, wherein the length of the first OFF pulse is greater than or equal to 1T and less than or equal to 3T, where T is one clock cycle, and the larger recording mark has a length which is an integral multiple of T.

5. An apparatus for recording information on a super-resolution optical recording medium by irradiating the medium with a laser beam in accordance with a pulse train, which is defined according to data to be recorded, in order to record information by forming a recording mark/space train that includes a recording mark/space which are smaller than a resolution limit of a reproduction optical system and a recording mark/space which are larger than or equal to the resolution limit, the apparatus comprising:
a head for irradiating the super-resolution optical recording medium with the laser beam;
a laser drive circuit for supplying to the head a laser drive signal for controllably modulating the laser beam into a recording pulse train; and
a laser control circuit for generating the laser drive signal such that a pulse train for forming the larger recording mark immediately after the smaller space includes at least a first ON pulse of recording power followed by a first OFF pulse and a second ON pulse in that order, and the first OFF pulse includes an OFF pulse of cooling power and an OFF pulse of middle power in that order.

6. The apparatus for recording information on a super-resolution optical recording medium according to claim 4, wherein the laser control circuit generates the laser drive signal so that the first OFF pulse has a length which is made equal to a length of a recording pulse for forming the smaller recording mark.

7. The apparatus for recording information on a super-resolution optical recording medium according to claim 5, wherein the laser control circuit generates the laser drive signal such that the length of the first OFF pulse is greater than or equal to 1T and less than or equal to 3T, where T is one clock cycle, and the larger recording mark has a length which is an integral multiple of T.

8. The apparatus for recording information on a super-resolution optical recording medium according to claim 6, wherein the laser control circuit generates the laser drive signal such that the length of the first OFF pulse is greater than or equal to 1T and less than or equal to 3T, where T is one clock cycle, and the larger recording mark has a length which is an integral multiple of T.
